(19) United States
(12) Patent Application Publication
(10) Pub. No.: US 2010/0125897 A1
(43) Pub. Date: May 20, 2010

(54) METHODS AND APPARATUS FOR ESTABLISHING A DYNAMIC VIRTUAL PRIVATE NETWORK CONNECTION

(76) Inventors: Rahul Jain, Bangalore (IN); Ryan Hope, King Of Prussia, PA (US)

Correspondence Address: WOLF GREENFIELD & SACKS, P.C., 600 ATLANTIC AVENUE, BOSTON, MA, 02210-2206, US

(21) Appl. No.: 12/274,623

(22) Filed: Nov. 20, 2008

(51) Int. Cl. H04L 9/32; G06F 12/14; G06F 15/16; G06F 12/16; H04L 9/00; G06F 9/00

(52) U.S. Cl. 726/7; 713/193; 726/15; 709/202; 713/150

(57) ABSTRACT

Methods and apparatus for managing a dynamic virtual private network (VPN) connection of an endpoint device using locally-stored encrypted VPN profiles. The endpoint device comprises a VPN client configured to establish a secure connection with a computer via a network, an encrypted datastore for storing the encrypted VPN profiles, and a security agent for monitoring a security compliance status of the endpoint device with a security policy stored on the endpoint device. In response to detecting a change in the security compliance status of the endpoint device, the security agent copies VPN profiles from the encrypted datastore to a storage location accessible to the VPN client. The VPN client is configured to use the copied VPN profiles to securely connect to the computer. Periodic update requests from the security agent to an administrative server enable updated VPN profiles or security policies to be downloaded and stored in the encrypted datastore.

### TECHNICAL FIELD

The present invention relates generally to computer network security, and more specifically to monitoring the security of digital communications over a computer network.

### BACKGROUND

The industrialized world is becoming increasingly dependent on computers and networks. Advances in the global telecommunication infrastructure have provided significant flexibility in the way organizations view their workforce. For example, increasing numbers of employees work from remote locations (e.g., home, hotel, airport, etc.) by accessing corporate resources via a secure connection to their employer's computer network. A well-known method of providing a secure connection to a network is to establish a Virtual Private Network (VPN), which is private network having secure lines created over a public network, such as the Internet. Virtual privacy of communications over a VPN is established using secure tunnels to encapsulate the data as it is transferred along the secure lines. The VPN enables a user to securely send data between two computers across a shared public network in a manner that emulates the security properties of a private point-to-point link.

In an illustrative VPN connection, an endpoint device such as a computer attempts to connect with a corporate network server using a VPN client installed on the computer. However, to protect the integrity of the corporate network, prior to allowing the computer to access the corporate network, it should be established that the computer will not provide a security threat to the corporate network. One approach to protect the integrity of a corporate network is to employ a concept generically referred to in the industry as “network access control” (NAC). NAC is a computer networking security concept and set of protocols designed to prevent rogue or infected computers from connecting to a network. This is accomplished by essentially isolating any endpoint device when it first connects to a network. If the endpoint device is considered vulnerable or infected and is potential threat to the network, it is said to be “out of compliance” or “non-compliant.” Alternatively, if the endpoint device is considered safe and not a threat to the network, it is said to be “in-compliance” or “compliant” with the specified security policies of the corporation and the network.

For example, before connecting to a secure network, an endpoint device can directly or indirectly connect to a networking device such as a Layer 2 Ethernet switch, Layer 3 router, wireless access point, wireless controller, wireless switch, etc., which has a capability to inspect endpoint device data frames or packets and make a decision regarding access permissions that should be granted to the endpoint device. The endpoint device remains isolated until an inspection of the endpoint has been performed, the inspection results have been examined, and the secure network achieves a level of comfort that the endpoint device does not pose a potential risk.

Although NAC appears to be a powerful concept, its implementation often requires upgrading network infrastructure and client software to allow inspection and remediation of the endpoint devices (e.g., computers) connecting to the network thereby making it expensive to implement and maintain.

### SUMMARY

Applicants have recognized and appreciated that network security for remote access may be improved by deploying a security agent on an endpoint device which remotely accesses a secure network. In some embodiments, the security agent repeatedly monitors the compliance of the endpoint device with a security policy stored on the endpoint device and only enables unrestricted access to the secure network if the endpoint device is in compliance with the security policy. In some embodiments in which it is determined that the endpoint device is not in compliance with at least one security policy, the security agent restricts access to the network by allowing the endpoint to access only a restricted portion of the network for remediation. In some embodiments, the security agent integrates with a VPN client on an endpoint device and manages one or more VPN profiles for regular and restricted network access and also allows for updating of the VPN profiles.

One embodiment is directed to a method for managing VPN profiles external to a VPN client installed on an endpoint device. The method comprises monitoring a security compliance status of the endpoint device with at least one security policy stored on the endpoint device, copying, in response to detecting a change in the security 1508688-2 compliance status, at least one archived VPN profile from an encrypted datastore to a storage location accessible to the VPN client, wherein the at least one archived VPN profile comprises first connection information, and configuring the VPN client to connect to a network using the first connection information in the at least one archived VPN profile.

Another embodiment is directed to a computer-readable medium encoded with a series of instructions that when executed by a endpoint device perform a method of updating VPN profiles stored on an endpoint device. The method comprises transmitting a profile update request from a security agent on the endpoint device to a profile server, the profile update request comprising authentication information including at least one set of security credentials, receiving, in response to the profile update request, a VPN profile file comprising a plurality of VPN profiles, parsing the VPN profile file to extract the plurality of VPN profiles, and storing the plurality of VPN profiles in an encrypted datastore on the endpoint device.

Another embodiment is directed to a method for providing an updated VPN profile file from a profile server to an endpoint device. The method comprises receiving a profile update request from a security agent on the endpoint device, the profile update request comprising authentication information including at least one set of security credentials, searching the profile server for the updated VPN profile file based at least in part on the authentication information, and transmitting, if found, the updated VPN profile file to the client on the endpoint device.

Another embodiment is directed to an apparatus for monitoring a compliance of a endpoint device with at least one security policy. The endpoint device comprises a VPN client configured to establish a secure connection with a computer via a network, an encrypted datastore for storing archived VPN profiles, wherein at least one of the archived VPN profiles comprises connection information used by the VPN client to establish the secure connection, and a security agent for monitoring the compliance of the endpoint device with the at least one security policy, wherein the security agent copies at least one VPN profile from the archived VPN profiles in the encrypted datastore to a storage location accessible to the VPN client, wherein the at least one VPN profile is copied based at least in part on the compliance of the endpoint device with the at least one security policy.

It should be appreciated that all combinations of the foregoing concepts and additional concepts discussed in greater detail below (provided that such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is diagram of a remote access computer system according to some embodiments of the invention;

FIG. 2 is a flow chart of a start-up process for a computer system according to embodiments of the invention;

FIG. 3 is a flow chart of a updating process for updating profiles according to embodiments of the invention;

FIG. 4 is a flow chart of a security compliance monitoring process according to embodiments of the invention;

FIG. 5 is a flow chart of a process for establishing a remote server connection according to embodiments of the invention; and

FIG. 6 is a diagram of an exemplary computer system on which embodiments of the invention may be implemented.

### DETAILED DESCRIPTION

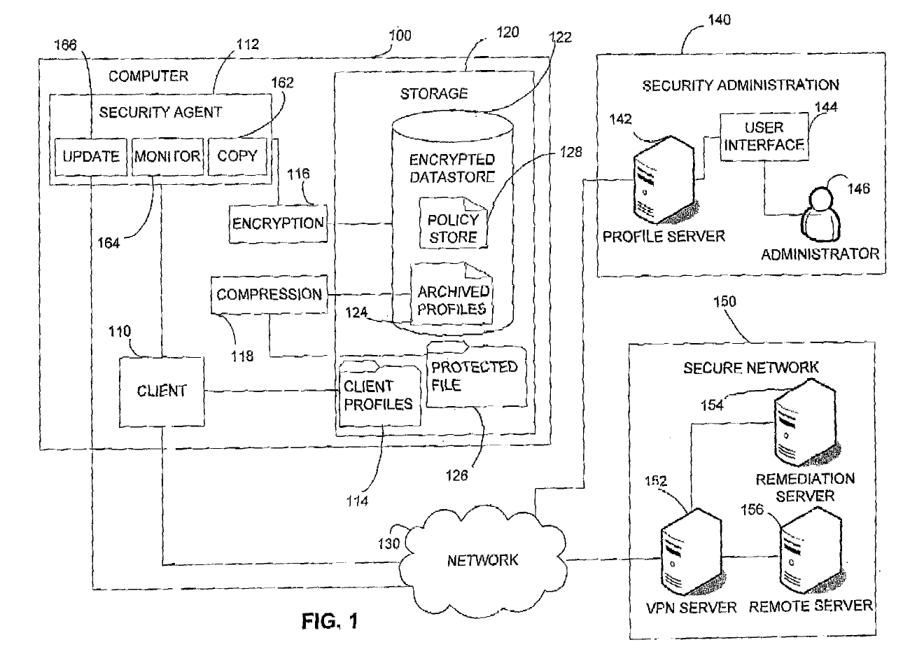

An exemplary embodiment of the present invention is illustrated in FIG. 1. FIG. 1 shows a computer system comprising a client 110 executing on a computer 100 having a connection to a network 130. In one embodiment, network 130 is a public network such as the Internet. Security administration 140 and secure network 150 are also connected to the network 130. In one embodiment, the client 110 may be a VPN client that is configured to establish a secure connection to one or more servers connected to the network 130 including, but not limited to, profile server 142 and VPN server 152. In one embodiment, profile server 142 is a server in a network of a service provider (e.g., an internet service provider) that hosts security administration 140 and VPN server 152 is included in secure network 150 which may be a corporate network of an organization to which a user of computer 100 is attempting to access. For example, VPN server 152 may be a VPN concentrator that manages secure remote access to the secure network 150.

The computer 100 additionally comprises storage 120 which may be a hard disk or some other form of volatile or non-volatile storage on which one or more VPN profiles may be stored. Storage 120 comprises encrypted datastore 122 which is configured to store one or more archived VPN profiles 124 and one or more security polices which have been received from profile server 142 (or some other server of security administration 140). Security policies stored in policy store 128 comprise compliance information that may be used to determine the compliance of computer 100. The archived VPN profiles 124 comprise at least some connection information that the VPN client 110 uses to establish a secure connection between the computer 100 (i.e., as an endpoint device) with VPN server 152 over network 130. It should be appreciated that storage 120 may be configured in any suitable way, and the above implementation is provided merely for illustrative purposes. For example, in an alternative implementation, security policies may be stored in a policy store 128 in an encrypted datastore that is separate from encrypted datastore 122 which stores the archived VPN profiles 124.

Computer 100 also comprises a security agent 112, which monitors the compliance of computer 100 with at least one security policy stored in the policy store 128. In one embodiment, the at least one security policy may be defined by administrator 146 by using user interface 144 to profile server 142, and may be transmitted from profile server 142 to security agent 112 periodically, or in response to a request from security agent 112. In one embodiment, security agent 112 is implemented as an application or a plurality of functions executing on computer 100. Security agent 112 comprises one or more facilities or components, such as copy facility 162, monitor facility 164, and update facility 166. Each of the facilities or components of security agent 112 may be implemented as an application programming interface (API) or other set of functions which integrate with security agent 112 to manage the VPN profiles 1508688-2 made accessible to VPN client 110. For example, in some embodiments, monitor facility 164 monitors the compliance of applications or processes executing on the computer 100 to determine if these applications or processes are in compliance with at least one security policy stored in policy store 128. For example, a security policy may require that prior to establishing a secure connection with VPN server 152 over network 130, that computer 100 does not contain malware such as spyware, and must be running a minimum version of an antivirus program or other security program. Security policies may include any number of suitable security requirements and embodiments of the invention are not limited in this respect.

In one embodiment, VPN client 110 may be implemented as software executing on computer 100. VPN client may use VPN profiles 114 stored in a client-accessible location on storage 120. The VPN profiles 114 store, among other things, connection information related to the VPN server 152, such as the VPN server Internet Protocol (IP) address or Universal Resource Locator (URL). VPN profiles 114 may also comprise authentication parameters, details of digital certificates used for authentication, or any other information used in establishing a secure connection between client 110 and VPN server 152. For example, permissions information in a VPN profile may be used by VPN server 152 to restrict access of an endpoint device to only a portion of the secure network 150.

As described above, VPN profiles 114 may be stored locally in storage 120 of computer 100, although VPN profiles 114 may be stored on any other storage that is accessible to client 110. In one embodiment, VPN profiles 114 are bundled with an installer program for VPN client 110, and are downloaded to storage 120 of computer 100 when the VPN client 110 is installed on computer 100. Alternatively, VPN profiles 114 may be distributed to computer 100 via network 130 via email, software distribution clients, or by any other suitable communication means.

In one embodiment, security agent 112 stores archived VPN profiles 124 in encrypted datastore 122 after a profile file has been received from profile server 142. In some embodiments, an initial set of archived VPN profiles 124 are bundled with an installer program for security agent 112, and the archived VPN profiles 124 are stored in encrypted datastore 122 when security agent 112 is installed on computer 100. Alternatively, archived VPN profiles 124 may be initially stored on profile server 142, and they may be downloaded from profile server 142 by security agent 112 over network 130 after the security agent 112 is installed on computer 100.

In one embodiment, archived VPN profiles 124 are categorized into at least two distinct types. Regular profiles allow unrestricted access to a secure network 150 and are made available to a user of computer 100 only when security agent 112 determines that computer 100 is in compliance with at least one security policy stored on the computer 100. In contrast, restricted profiles are made available to a user of computer 100 when security agent 112 determines that the computer 100 is not in compliance with at least one security policy stored on the computer 100. Restricted profiles define connection information which enables VPN server 152 to restrict access of computer 100 to only a restricted portion of the secure network 150. In some embodiments, restricted profiles allow computer 100 to connect to a VPN server that provides access to a restricted network with one or more remediation servers 154 for remediation, such as updating out-of-date security applications, or to access programs which facilitate removing malware from computer 100.

After remediation, in some embodiments, security agent 112 may determine that computer 100 has been sufficiently remediated and is in compliance with the at least one security policy. Accordingly, the security agent 112 allows the regular profiles to be made available to the user of computer 100 so that the client 110 may establish an unrestricted secure connection to secure network 150. In one embodiment, at least one attribute or definition stored in a profile is used by security agent 112 to determine if an archived VPN profile 124 is a regular profile or a restricted profile, although other suitable identification methods for profiles may also be used.

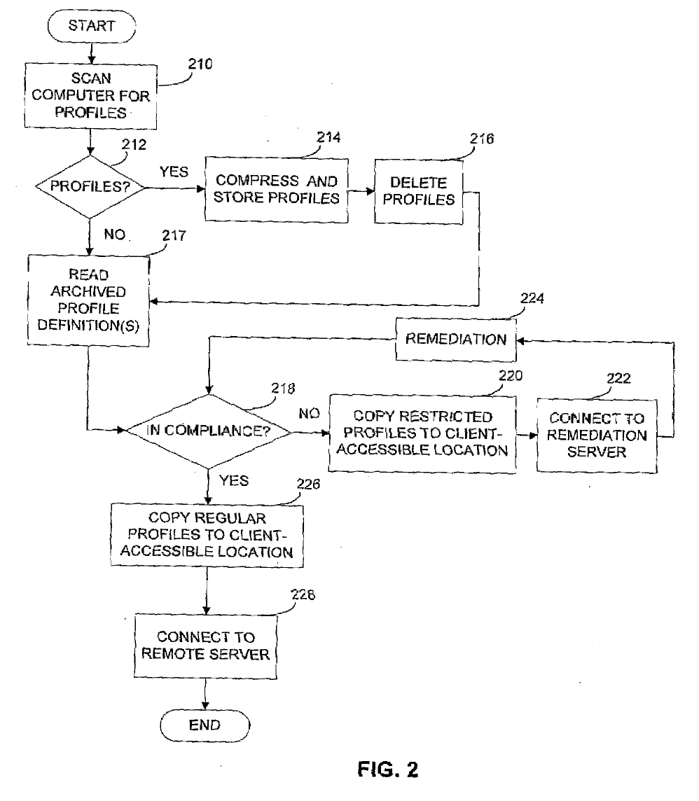

In one embodiment, security agent 112 is configured to determine a security compliance status of computer 100 upon start-up of computer 100 as shown in FIG. 2. In act 210, security agent 112 scans storage 120 for any locally-stored VPN profiles 114 by searching locations of storage 120 accessible to VPN client 110 (e.g., locations other than encrypted datastore 122). If it is determined in act 212 that VPN profiles 114 exist on the storage 120, the profiles may be compressed and stored in a separate file on storage 120 as a protected file 126. In one embodiment, the profiles 114 may be compressed by compression facility 118 executing on computer 100, and the compressed profiles may be encrypted by encryption facility 116 and stored in a protected file 126. Storing copies of preexisting VPN profiles 114 upon start-up of computer 100 preserves the previous configuration state of the profiles available to a user of computer 100 so that if problems occur during start-up (e.g., power failure, etc.), client 110 may still be able to access network 130 using one or more of the preexisting profiles stored in protected file 126. The profiles stored in protected file 126 may be compressed and/or encrypted in any suitable way, and embodiments of the invention are not limited in this respect. For example, in one embodiment, protected file 126 is an encrypted zip file comprising VPN profiles from the last time that the computer 100 was activated.

After any preexisting local profiles have been compressed and stored in a protected file 126, security agent 112 deletes VPN profiles 114 from the storage 120 in act 216. After deletion of the VPN profiles 114, or if no local profiles were detected in act 212, the security agent 112 determines a security compliance status of the computer 100 in act 218. In one embodiment, security agent 112 queries applications or other processes executing on computer 100 for security information. The security information may include, for example, whether or not computer 100 has an antivirus program executing thereon and the version of the antivirus program. In one embodiment, the security compliance status may be determined by monitor facility 164 and the security compliance status may be stored on storage 120 in a location that is accessible to the one or more facilities or components of security agent 112.

In act 217, monitor facility 164 accesses at least one security policy in policy store 128. In one embodiment, policy store 128 comprises multiple security policies and monitor facility 164 selects the most restrictive security policy from among the security policies stored in policy store 128. However, it should be appreciated that a security policy may be selected from policy store 128 in any other suitable way including, but not limited to, selecting the most recently downloaded security policy. After selecting the at least one security policy from the policy store 128, the monitor facility 164 determines the security compliance status of computer 100 based at least in part on the detected security information and the at least one security policy. The security compliance status of computer 100 may be used to instruct security agent 112 to copy one or more profiles from archived VPN profiles 124 into a client-accessible location on storage 120.

If it is determined in act 218 that the computer 100 is not in compliance with at least one security policy, in act 220, the security agent 112 copies restricted profiles from the encrypted datastore 122 to a client-accessible location on storage 120 as client profiles 114. In one embodiment, copy facility 162 identifies the restricted profiles stored in encrypted datastore 122 by examining attributes or definitions included as a portion of each of the archived VPN profiles 124 stored in encrypted datastore 122.

Applicants have recognized and appreciated that locally stored copies of VPN profiles if not properly secured (e.g., via encryption) become security threats to ensuring an uncorrupted VPN connection to secure network 150 if, for example, a user of computer 100 accesses and modifies a VPN profile to circumvent security policies incorporated to protect the integrity of the secure network 150. Thus, in some embodiments of the invention, access to the archived VPN profiles 124 and security policies stored in encrypted datastore 122 is restricted to the security agent 112 in order to prevent tampering with the VPN profiles by a user of the computer 100. In order to gain access to the archived VPN profiles 124 and security policies stored in the encrypted datastore 122, copy facility 162 of security agent 112 may provide local authentication information to an encryption facility 116 implemented in one embodiment as a gateway to encrypted datastore 122. It should be appreciated that to prevent tampering with files in encrypted datastore 122, the user of computer 100 may not directly access files stored therein. Rather, access to files stored in encrypted datastore 122 may, in some embodiments, be only accessible by security agent 112.

Following verification of the local authentication information by encryption facility 116, copy facility 162 proceeds to copy all restricted profiles from the archived VPN profiles 124 to a client-accessible location on storage 120 as VPN profiles 114, thereby enabling client 110 to use connection information in the VPN profiles 114 to establish a secure connection to a portion of secure network 150 for remediation.

In one embodiment, after the restricted profiles are made available to client 110, a user of computer 100 may be prompted to select one of the restricted profiles for connecting to VPN server 152 which provides access to a restricted network comprising remediation server 154. For example, a digital message may be transmitted to a user interface of computer 100 which displays the message to the user. The user may interact with the user interface to select one of the available restricted profiles, and upon selecting one of the restricted profiles in act 222, the client 110 may establish a secure connection to VPN server 152 which provides access to a restricted network comprising remediation server 154, according to the connection information in the selected restricted profile. In other embodiments, user intervention may not be necessary to select a restricted profile, and a connection to remediation server 154 may be established automatically by client 110 after the restricted profiles have been made accessible to the client 110. In such embodiments, provided that more than one restricted profile is accessible to client 110, security agent 112 may select a restricted profile in any suitable way. For example, the restricted profiles may comprise at least one attribute that specifies a priority connection order for establishing a secure connection to VPN server 152, and the security agent 112 may select one of the restricted profiles based at least in part on the priority connection order.

In act 224, a user of computer 100 may select one or more applications on computer 100 for remediation so that the one or more applications may be brought into compliance with at least one security policy. In one embodiment, connection to VPN server 152 which provides access to a restricted network comprising remediation server 154 comprises launching a web-browser on computer 100 directed to a website hosted by remediation server 154. In one implementation, the website may comprise a listing of hypertext links to which the user may click on and navigate to other websites to update one or more applications on computer 100. Remediation server 154 may itself store one or more executable applications which may be used to remediate at least some non-compliant issues identified by the security agent 112. For example, if security agent 112 identified that computer 100 had spyware installed thereon, one or more programs stored on remediation server may be used to scan for and eliminate the spyware on computer 100. In one embodiment, some remediation programs (e.g., for malware removal) may be downloaded to computer 100 and executed locally, however, in other embodiments, at least some remediation programs may be executed remotely without the need to download the programs to computer 100. Although the foregoing discussion of a web-based interface for remediation server 154 is in accordance with at least one exemplary embodiment of the invention, it should be appreciated that remediation of computer 100 may be accomplished in any suitable way including, but not limited to, transmitting a list of required updates and/or remediation programs from remediation server 154 to computer 100 as an electronic mail (e-mail) message, using a secure file transfer protocol, or by any other suitable communication means.

After remediation in act 224, security agent 112 may re-assess the compliance of computer 100 with at least one security policy in act 218. If sufficient remediation has not taken place, an indication may be provided to the user of computer 100 that further remediation is required. However, if security agent 112 determines in act 218 that the computer 100 is in compliance with at least one security policy, copy facility 162 copies all regular profiles from encrypted datastore 122 to a client-accessible location on storage 120 as client profiles 114 in act 226. In one embodiment, security agent 112 deletes all client-accessible restricted profiles prior to copying regular profiles from the encrypted datastore 122. By deleting all restricted profiles, only the regular profiles are made accessible to a user for enabling client 110 to establish a secure connection to remote server 156 via network 130 and VPN server 152. In some embodiments, deleting restricted profiles and/or copying regular profiles from the encrypted datastore 122 may not occur immediately after it is determined in act 218 that the computer 100 is in compliance with the at least one security policy. Rather, in some embodiments, security agent 112 may wait until the user of computer 100 discontinues the use of one or more restricted profiles before deleting the restricted profiles and/or copying the regular profiles from the encrypted datastore 122.

In act 228, a user may select a regular profile comprising connection information that client 110 may use to connect to remote server 156 using a VPN connection over network 130. As described above with regard to restricted profiles, in some embodiments, user intervention for selecting a regular profile to establish an unrestricted VPN connection to secure network 150 may not be required, and security agent 112 may automatically select a regular profile based at least in part on one or more attributes or definitions (e.g., specifying a desired connection priority order) stored in the regular VPN profiles.

As described above, regular profiles permit client 110 to establish an unrestricted VPN connection to remote server 156 to enable the user of computer 100 to access one or more resources of secure network 150 from a remote location. In one embodiment, a user may have more than one regular profile for establishing a secure connection to remote server 156. For example, one profile may specify first connection information for establishing a secure connection from a user's office at home, and another profile may specify second connection information for establishing a secure connection when the user is travelling in a different country. It should be appreciated that a user of computer 100 may have any number of regular or restricted profiles and embodiments of the invention are not limited in this respect. Since, in some embodiments, all profiles stored locally on storage 120 of computer 100 are deleted by security agent 112 upon start-up, and security agent 112 copies the relevant VPN profiles from encrypted datastore 122 to a client-accessible location on storage 120 based on the security compliance status of computer 100, the user of computer 100 may only access a portion of secure network 150 containing remote server 156 when computer 100 is in compliance with one or more security policies defined by the security administrator 146 of security administration 140.

As described above, in one embodiment, security agent 112 is configured to acquire one or more VPN profile files from an online server such as profile server 142 that hosts the one or more VPN profile files. Profile server 142 may be an authenticated file server that security agent 112 contacts at a periodic intervals (e.g. once every 3 hours) to check for updates to a VPN profile file. In some embodiments, security agent 112 may also request one or more updated security policies from an online server in security administration network 140. The updated security policies may be stored on profile server 142 or on another server in security administration 140, and embodiments of the invention are not limited in this respect.

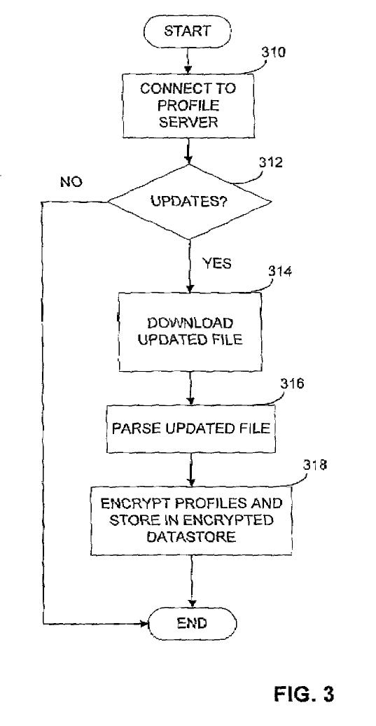

A process for receiving VPN profile files from profile server 142 is illustrated in FIG. 3. In act 310, security agent 112 connects to profile server 142 using an authenticated connection. As described above, security agent 112 may comprise an update facility 166 which initiates and coordinates communications with profile server 142 over network 130. In one embodiment, update facility 166 is a network access client which communicates with profile server 142 to request and download VPN profile and/or security policy updates from profile server 142 (or another server in security administration 140) over network 130. However, it should be appreciated that computer 100 may additionally comprise one or more other network access clients for communicating with network 130, and security agent 112 may alternatively direct any of these one or more other network access clients to communicate with profile server 142.

In one embodiment, profile server 142 is an authenticated file server and each profile update request to profile server 142 from client 110 comprises update authentication information including at least one set of security credentials (e.g., username and password) needed to access VPN profile files stored on the profile server 142. If the profile server 142 determines that the update authentication information is not valid, profile server 142 may send an error message to security agent 112 to indicate that the profile update request failed. The profile server may use any suitable authentication method for authenticating the profile update request, and embodiments of the invention are not limited in this respect.

Upon authentication of a profile update request from client 110 by profile server 142, it is determined in act 312 whether or not an updated profile file exists on profile server 142. This determination may be accomplished by profile server 142 in any suitable manner. For example, software executing on profile server 142 may search for an updated VPN profile file based on a provided security credential in the profile update request. If an updated profile file is not detected in response the profile update request, then a notification is transmitted from profile server 142 to computer 100 that no updates are available and the updating process ends. Otherwise, if an updated profile file is detected in response to the profile update request, the updated profile file is transmitted from the profile server 142 to security agent 112 over network 130.

In one embodiment, profile files stored on profile server 142 comprise a plurality of VPN profiles bundled together in an extensible markup language (XML) file. An implementation using XML files is merely exemplary, and it should be appreciated that VPN profile files stored on profile server 142 may be stored in any suitable way. In one embodiment, a security administrator 146 may update the contents of VPN profile files and/or security policies stored on the profile server 142 via a user interface 144. As described above, updates to one or more VPN profile files may be detected in response to a profile update request from security agent 112, and the corresponding updated VPN profile file or security policy is transmitted to computer 100 in response to the request. Any suitable secure file transfer protocol, such as secure HTTP (https) may be used to transfer VPN profile files and security policies from profile server 142 to computer 100 via network 130 and embodiments of the invention are not limited in this respect.

In one embodiment, a VPN profile file configured as an XML file is received at computer 100 from profile server 142 and is parsed in act 316 by security agent 112 to extract a plurality of VPN profiles stored therein. For example, update facility 166 may be configured to parse XML-based VPN profile files into a plurality of regular and restricted VPN profiles defined for the user of computer 100 by security administrator 146. In act 318, the parsed VPN profiles may be encrypted by encryption facility 116 and stored in encryption datastore 122 as archived VPN profiles 124. As discussed above, based on the compliance of the computer 100 with at least one security policy, security agent 112 may copy some of the archived VPN profiles 124 to a client-accessible location on storage 120 so that client 110 may use the VPN profiles to establish a VPN connection with VPN server 152 of secure network 150.

In one embodiment, the security compliance status of computer 100 may be checked whenever an updated profile file or security policy is received at computer 100. Thus, compliance with one or more updated security policies defined by security administrator 146 may be determined to assess if remediation of the computer 100 is required. In some embodiments, however, security agent 112 may not determine the security compliance status of computer 100 upon receiving an updated profile file or security policy, but instead, the security compliance status of computer 100 may be determined using a compliance monitoring process described in more detail below.

In one embodiment, security agent 112 monitors the security compliance status of computer 100 relative to at least one security policy at predetermined time intervals. For example, the security agent may determine the security compliance status every 5 or 10 seconds and take appropriate actions if the security compliance status has changed. The at least one security policy may be defined by security administrator 146 or by any other authorized person and may be stored in policy store 128 in encrypted datastore 122 (or some other encrypted datastore in storage 120). As described above, one or more security policies define, among other things, security applications (e.g., antivirus programs) that must be executing on computer 100, a maximum allowed age for a virus definition file, a list of applications not allowed to execute on computer 100, etc. In one embodiment, the security compliance status of computer 100 is periodically updated by security agent 112 in an in-memory repository from where the security compliance status may be accessed by the one or more facilities of security agent 112.

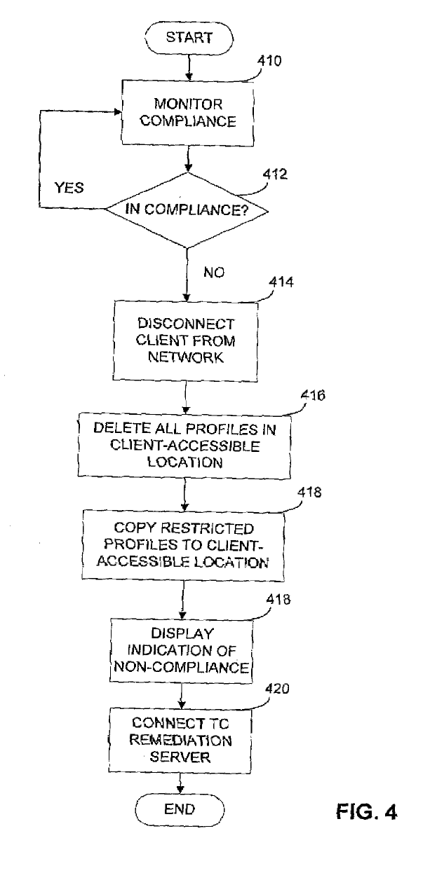

Applicants have recognized and appreciated that a dynamic VPN tunnel may be created between endpoint devices such as computer 100 and secure network 150 by employing a security agent 112 on computer 100 to monitor the security compliance status of computer 100, and to direct VPN client 110 to take appropriate actions if the security compliance status changes over the course of a VPN session. A monitoring process according to one embodiment of the invention is described with reference to FIG. 4. In act 410, monitor facility 164 of security agent 112 monitors the compliance of computer 100 by assessing security information gathered by various means including, but not limited to querying applications and processes executing on computer 100 to determine if required security applications are executing and ensuring that forbidden applications are not executing. For example, a security policy may specify that in order to be in compliance, computer 100 must be executing an antivirus application and cannot be executing an instant messenger (IM) application. During the course of a VPN session, if the user of computer 100 decides to stop execution of an antivirus application or alternatively, to start executing an IM application, monitor facility 164 detects a change in security compliance status from compliant to non-compliant, and initiates one or more actions to address the change in the security compliance status.

When security agent 112 determines in act 412 that the security compliance status of computer 100 has changed from compliant to non-compliant, the security agent transmits a digital message to VPN client 110 in act 414 to disconnect from the VPN server 152 if connected. In act 416, the security agent 112 deletes all of the VPN profiles 114 in the client-accessible location on storage 120. Then in act 418, copy facility 162 copies all restricted profiles from archived VPN profiles 124 in encrypted datastore 122 to the client-accessible location on storage 120, thereby making available to the user of computer 100 only restricted profiles which enable computer 100 to access only a restricted portion of secure network 150 for remediation (e.g., via remediation server 154). In act 418, security agent 112 sends a digital message to a display of computer 100 to inform the user of computer 100 that the security compliance status has changed to non-compliant. In one embodiment, the displayed message also includes one or more reasons why the computer has become non-compliant.

In act 420, the user of computer 100 may interact with a user interface to select one of the restricted profiles to connect to a restricted portion of secure network 150 comprising remediation server 154. Alternatively, the user may choose to remedy any non-compliance issues of computer 100 without the help of remediation server 154. For example, the user may choose to restart an antivirus application that was stopped, or to finish an IM session, and then discontinue execution of the IM application. In some embodiments, the security agent 112 may require that any issues inconsistent with the at least one security policy used to determine the security compliance status are resolved before allowing an unrestricted VPN connection to remote server 156 via VPN server 152.

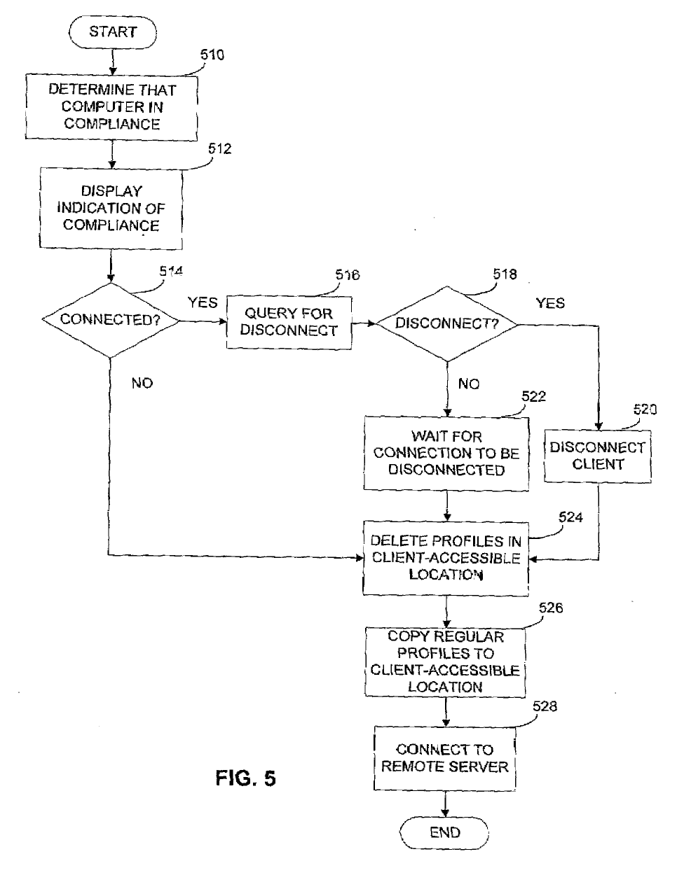

FIG. 5 illustrates a process according to one embodiment of the invention, for restoring a VPN session after a user of computer 100 has taken steps to rectify non-compliance issues related to at least one security policy stored thereon. In act 510, monitoring facility 164 of security agent 112 determines that the security compliance status of computer 100 should be changed from non-compliant to compliant in accordance with at least one security policy. In act 512, security agent 112 sends a digital message to a display of computer 100 to inform the user that computer 100 has been brought back into compliance with at least one security policy. In act 514, the security agent 112 queries the client 110 to determine if the computer 100 is connected to the secure network 150 (e.g., to remediation server 154). If it is determined in act 514 that the computer is connected, the security agent 112 may send a digital message to the display of computer 100 in act 516 to ask the user if the connection may be terminated. In response, the user of computer 100 may interact with a user interface to select whether or not the connection may be terminated. In act 518, if it is determined that the user wants to terminate the connection, security agent 112 sends a digital message to client 100 to disconnect from secure network 150. Otherwise, if the user of computer 100 indicates in act 518 that the connection is to be maintained, security agent 112 waits in act 522 until the connection is terminated either by the user or by an application or process executing on computer 100.

If it is determined in act 514 that computer 100 is not connected to secure network 150, or after computer 100 is disconnected in either act 520 or act 522, security agent 112 deletes all profiles in the client-accessible location of storage 120 in act 524. Prior to deleting all profiles in act 524, in some embodiments, the profiles may be compressed and encrypted in a protected file 126 stored on storage 120. In act 526, copy facility 162 of security agent 112 copies all regular profiles from archived VPN profiles 124 in encrypted datastore 122 to a client-accessible location of storage 120 as client profiles 114, thereby enabling all regular profiles to be made available to the user of computer 100 to establish a VPN with VPN server 152 of secure network 150 using VPN client 110.

After making the regular VPN profiles available to the user of computer 100, the user may be queried in act 528 to select one of the regular profiles for VPN client 110 to use in establishing a VPN connection with VPN server 152 of secure network 150. The user may then select one of the regular profiles, and the client 110 uses the connection information in the selected VPN profile to establish a VPN session with the secure network 150 according to the definitions described in the selected VPN profile.

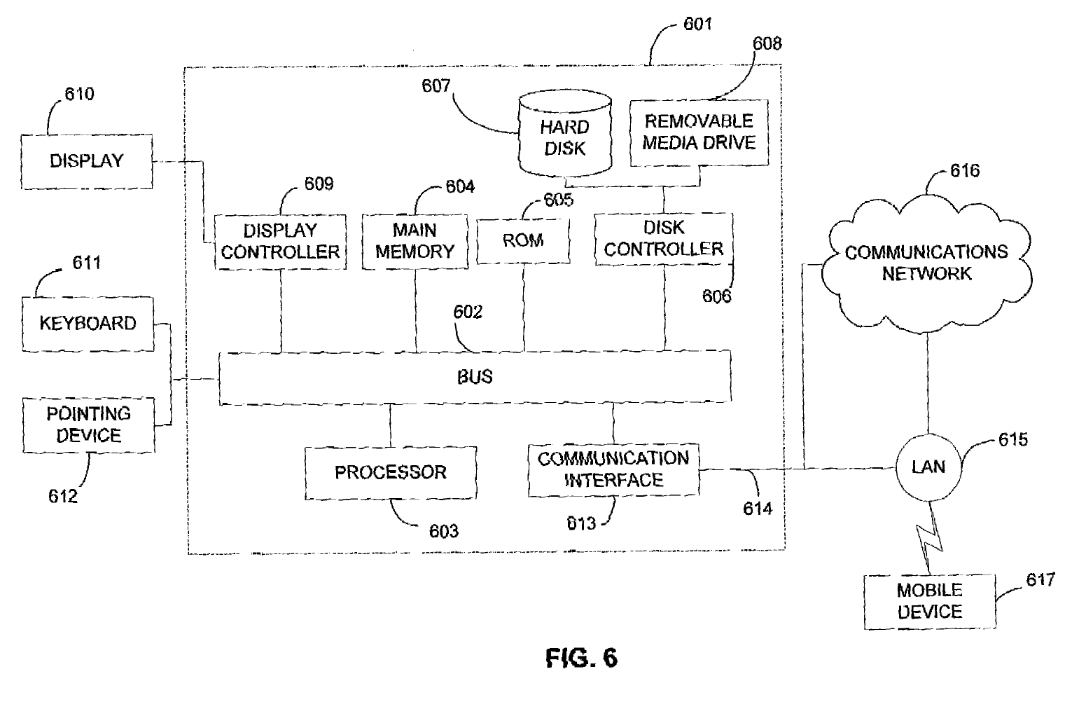

FIG. 6 illustrates a computer system 601 upon which embodiments of the invention may be implemented. The computer system 601 includes a bus 602 or other communication mechanism for communicating information, and a processor 603 coupled with the bus 602 for processing the information. The computer system 601 also includes a main memory 604, such as a random access memory (RAM) or other dynamic storage device (e.g., dynamic RAM (DRAM), static RAM (SRAM), and synchronous DRAM (SDRAM), coupled to the bus 602 for storing information and instructions to be executed by processor 603. In addition, the main memory 604 may be used for storing temporary variables or other intermediate information during the execution of instructions by the processor 603. The computer system 601 further includes a read only memory (ROM) 605 or other static storage device (e.g., programmable ROM (PROM), erasable PROM (EPROM), and electrically erasable PROM (EEPROM) coupled to the bus 602 for storing static information and instructions for the processor 603.

The computer system 601 also includes a disk controller 606 coupled to the bus 602 to control one or more storage devices for storing information and instructions, such as a magnetic hard disk 607, a removable media drive 608 (e.g., floppy disk drive, read-only compact disc drive, read/write compact disc drive, compact disc jukebox, tape drive, and removable magneto-optical drive). The storage devices may be added to the computer system 601 using an appropriate device interface (e.g., a small computer system interface (SCSI), integrated device electronics (IDE), enhanced-IDE (E-IDE), direct memory access (DMA), or ultra-DMA.

The computer system 601 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 601 may also include a display controller 609 coupled to the bus 602 to control a display 610, such as a cathode ray tube (CRT) or liquid crystal display (LCD), for displaying information to a computer user. The computer system includes input devices, such as a keyboard 611 and a pointing device 612, for interacting with a computer user and providing information to the processor 603. The pointing device 612, for example, may be a mouse, a trackball, or a pointing stick for communicating direction information and command selections to the processor 603 and for controlling cursor movement on the display 610. In addition, a printer may provide printed listings of data stored and/or generated by the computer system 601.

The computer system 601 performs a portion or all of the processing steps of embodiments of the invention in response to the processor 603 executing one or more sequences of one or more instructions contained in a memory, such as the main memory 604. Such instructions may be read into the main memory 604 from another computer readable medium, such as a hard disk 607 or a removable media drive 608. The hard disk 607 may contain one or more datastores and data files used by client 110. Datastore contents and data files may be encrypted to improve security. One or more processors in a multi-processing arrangement may also be employed to execute the one or more sequences of instructions contained in main memory 604. In alternative embodiments, hard-wired circuitry may be used in place of or in combination with software instructions. Thus, embodiments are not limited to any specific combination of hardware circuitry and software.

As stated above, the computer system 601 includes at least one computer readable medium or memory for holding instructions programmed according embodiments of the invention and for containing data structures, tables, records, or other data described herein. Non-limiting examples of computer readable media include hard disks, floppy disks, tape, magneto-optical disks, PROMs (EPROM, EEPROM, flash EPROM), DRAM SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read instructions.

Stored on any one or on a combination of computer readable media, embodiments of the present invention include software for controlling the computer system 601, for driving a device or devices for implementing the invention, and for enabling the computer system 601 to interact with a human user. Such software may include, but is not limited to, device drivers, operating systems, development tools, and applications software. Such computer readable media further comprises a computer program product for performing all or a portion (if processing is distributed) of the processing performed in implementing embodiments of the invention.

Components of the computer system 601 which interpret one or more sequences of instructions may be any interpretable or executable code component including, but not limited to, scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 603 for execution. A computer readable medium may take many forms including, but not limited to, non-volatile media, volatile media, and transmission media. Non-limiting examples of non-volatile media include optical, magnetic disks, and magneto-optical disks, such as hard disk 607 or removable media drive 608. Non-limiting examples of volatile media include dynamic memory, such as main memory 604. Non-limiting examples of transmission media include coaxial cables, copper wire, and fiber optics, including the wires that make up the bus 602. Transmission media may also take the form of acoustic or light waves, such as those generated during radio wave and infrared data communications.

Various forms of computer readable media may be involved in carrying out one or more sequences of one or more instructions to processor 603 for execution. For example, the instructions may initially be carried on a magnetic disk of a remote computer. The remote computer may load the instructions for implementing all or a portion of the present invention remotely into dynamic memory and send the instructions over a telephone line using a modem. A modem local to the computer system 601 may receive the data on the telephone line and use an infrared transmitter to convert the data to an infrared signal. An infrared detector coupled to the bus 602 may receive the data carried in the infrared signal and place the data on the bus 602. The bus 602 carries the data to the main memory 604, from which the processor 603 retrieves and executes the instructions. The instructions received by the main memory 604 may optionally be stored on storage device 607 or 608 either before or after execution by processor 603.

The computer system 601 also includes a communication interface 613 coupled to the bus 602. The communication interface 613 provides a two-way data communication coupling to a network link 614 that is connected to, for example, a local area network (LAN) 615, or to another communications network 616, such as the Internet. For example, the communication interface 613 may be a network interface card to attach to any packet switched LAN. As another example, the communication interface 613 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 613 sends and receives electrical, electromagnetic, or optical signals that carry digital data streams representing various types of information.

The network link 614 typically provides data communications through one or more networks to other data devices. For example, the network link 614 may provide a connection to another computer through a local network 615 (e.g., a LAN) or through equipment operated by a network service provider, which provides communication services through a communications network 616. The local network 614 and the communications network 616 use, for example, electrical, electromagnetic, or optical signals that carry digital data streams, and the associated physical layer (e.g., CAT 5 cable, coaxial cable, optical fiber, etc.). The signals through the various networks and the signals on the network link 614 and through the communication interface 613, which carry the digital data to and from the computer system 601 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase, and/or frequency shift keyed signals that are propagated over a conductive media, or transmitted as electromagnetic waves through a propagation medium. Thus, the digital data may be sent as unmodulated baseband data through a “wired’ communication channel and/or sent within a predetermined frequency band, different than the baseband, by modulating a carrier wave. The computer system 601 may transmit and receive data, including program code, through the network(s) 615 and 616, the network link 614, and the communication interface 613. Moreover, the network link 614 may provide a connection through a KAN 615 to a mobile device 617, such as a personal digital assistant (PDA), laptop computer, or cellular telephone.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for managing VPN profiles external to a VPN client installed on an endpoint device, the method comprising:
monitoring a security compliance status of the endpoint device with at least one security policy stored on the endpoint device;
copying, in response to detecting a change in the security compliance status, at least one archived VPN profile from an encrypted datastore to a storage location accessible to the VPN client, wherein the at least one archived VPN profile comprises first connection information; and
configuring the VPN client to connect to a network using the first connection information in the at least one archived VPN profile.

2. The method of claim 1 further comprising: establishing a first VPN connection with a computer over the network using the VPN client to provide access to a first portion of a secure network.

3. The method of claim 2 further comprising:
detecting a change in the security compliance status of the endpoint device; and
disconnecting the first VPN connection in response to detecting the change in the security compliance status.

4. The method of claim 3 further comprising:
displaying an indication to a user of the endpoint device that the security compliance status of the endpoint device has changed.

5. The method of claim 4, wherein detecting a change in the security compliance status of the endpoint device comprises detecting that the endpoint device is non-compliant with the at least one security policy.

6. The method of claim 5 further comprising:
deleting the at least one archived VPN profile at the storage location accessible to the VPN client;
copying at least one restricted profile from the VPN profiles in the encrypted datastore to the storage location accessible to the VPN client, wherein the at least one restricted profile comprises second connection information; and
configuring the VPN client to connect to the network using the second connection information in the at least one restricted profile.

7. The method of claim 6, further comprising:
establishing a second VPN connection with the computer over the network using the VPN client to provide access to a second portion of the secure network; and
receiving information from the computer to modify at least one application on the endpoint device.

8. The method of claim 4, wherein detecting a change in the security compliance status of the endpoint device comprises detecting that the endpoint device is compliant with the at least one security policy, the method further comprising displaying an indication of the security compliance status to a user of the endpoint device.

9. The method of claim 8, further comprising:
deleting the at least one archived VPN profile at the storage location accessible to the VPN client;
copying at least one regular profile from the VPN profiles in the encrypted datastore to the storage location accessible to the VPN client, wherein the at least one regular profile comprises third connection information;
configuring the VPN client to connect to the network using the third connection information in the at least one regular profile; and
establishing a second VPN connection over the network using the VPN client.

10. A computer-readable medium encoded with a series of instructions that when executed by a endpoint device perform a method of updating VPN profiles stored on an endpoint device, the method comprising:
transmitting a profile update request from a security agent on the endpoint device to a profile server, the profile update request comprising authentication information including at least one set of security credentials;
receiving, in response to the profile update request, a VPN profile file comprising a plurality of VPN profiles;
parsing the VPN profile file to extract the plurality of VPN profiles; and
storing the plurality of VPN profiles in an encrypted datastore on the endpoint device.

11. The computer-readable medium of claim 10, wherein the VPN profile file is an XML file, and parsing the VPN profile file comprises parsing the XML file.

12. The computer-readable medium of claim 10, further comprising:
monitoring a security compliance status of the endpoint device with at least one security policy stored on the endpoint device;
copying, in response to detecting a change in the security compliance status, at least one of the plurality of VPN profiles from the encrypted datastore to a storage location accessible to the VPN client, wherein the at least one of the plurality of VPN profiles comprises connection information; and
configuring the VPN client to connect to a network using the connection information.

13. The computer-readable medium of claim 12, further comprising: establishing a VPN connection with a computer over the network using the VPN client.

14. A method for providing an updated VPN profile file from a profile server to an endpoint device, the method comprising:
receiving a profile update request from a security agent on the endpoint device, the profile update request comprising authentication information including at least one set of security credentials;
searching the profile server for the updated VPN profile file based at least in part on the authentication information; and
transmitting, if found, the updated VPN profile file to the client on the endpoint device.

15. The method of claim 14, wherein the profile server is an authenticated file server, the method further comprising:
transmitting an error message to the security agent if the profile server determines that the authentication information is not valid.

16. The method of claim 14, wherein the VPN profile file is an XML file comprising a plurality of VPN profiles.

17. The method of claim 14, wherein the updated profile file comprises at least one new VPN profile.

18. An apparatus for monitoring a compliance of a endpoint device with at least one security policy, the endpoint device comprising:
a VPN client configured to establish a secure connection with a computer via a network;
an encrypted datastore for storing archived VPN profiles, wherein at least one of the archived VPN profiles comprises connection information used by the VPN client to establish the secure connection; and
a security agent for monitoring the compliance of the endpoint device with the at least one security policy, wherein the security agent copies at least one VPN profile from the archived VPN profiles in the encrypted datastore to a storage location accessible to the VPN client, wherein the at least one VPN profile is copied based at least in part on the compliance of the endpoint device with the at least one security policy.

19. The apparatus of claim 18, wherein the archived VPN profiles comprises at least one regular profile, the at least one regular profile permitting the VPN client to establish an unrestricted VPN connection to the computer over the network, and at least one restricted profile, the at least one restricted profile permitting the VPN client to establish a restricted connection to the computer over the network.

20. The apparatus of claim 19, wherein the security agent is configured to copy the at least one regular profile from the encrypted datastore to the storage location accessible to the VPN client when the endpoint device is in compliance with the at least one security policy.

21. The apparatus of claim 19, wherein the security agent is configured to copy the at least one restricted profile from the encrypted datastore to the storage location accessible to the VPN client when the end user device is not in compliance with the at least one security policy.

22. The apparatus of claim 18, wherein the security agent comprises a copy facility for copying the at least one VPN profile from the archived VPN profiles in the encrypted datastore to a storage location accessible to the VPN client.

23. The apparatus of claim 18, wherein the security agent comprises an update facility for transmitting a profile update request to a profile server, wherein the profile update request comprises authentication information including at least one set of security credentials.
